(19) United States
(12) Patent Application Publication
(10) Pub. No.: US 2026/0175303 A1
(43) Pub. Date: Jun. 25, 2026

(54) MILLING TOOL AND METHOD FOR CHAMFERING FLANK EDGES OF TEETH ON A CYLINDRICAL TOOTHED WORKPIECE

(71) Applicant: AB SANDVIK COROMANT, Sandviken (SE)

(72) Inventors: Swetapadma MOHANTY, Sandviken (SE); Tong JIA, Sandviken (SE); Achim BOSCH, Sandviken (SE)

(21) Appl. No.: 19/127,548

(22) PCT Filed: Oct. 12, 2023
(86) PCT No.: PCT/EP2023/078370

§ 371 Date: May 6, 2025

(30) Foreign Application Priority Data
Nov. 8, 2022 (EP) 22205957.8

(51) Int. Cl. B23C 5/10; B23C 5/06; B23C 5/18; B23C 5/20

(52) U.S. Cl. CPC B23C 5/10; B23C 5/06; B23C 5/18; B23C 5/202; B23C 2200/208

(57) ABSTRACT

A milling tool is provided for chamfering flank edges of teeth on a cylindrical toothed workpiece having an elongated tool body with a rear part configured for attachment to a machine, a cutting part and an elongated shank part, which carries the cutting part and extends from the cutting part towards the rear part. The cutting part includes a first cutting edge facing away from the rear part and a second cutting edge facing the rear part and located closer to the rear part than the first cutting edge. The distance between the second cutting edge and an axis of rotation of the tool body gradually increases from a rear end of the cutting edge to a front end thereof, the rear end being located at a longer distance from the axis of rotation than a radially outermost part of a peripheral surface of the shank part.

### FIELD OF THE INVENTION AND PRIOR ART

The present invention relates to a milling tool according to the preamble of claim 1 for chamfering flank edges of internal or external teeth on a cylindrical toothed workpiece at opposite end faces of the workpiece. The invention also relates to a method for chamfering such flank edges.

External or internal gear teeth or spline teeth may be machined on a cylindrical workpiece by cutting technologies using different types of cutting tools. In such a case, the resulting teeth on the workpiece will have burrs and sharp edges at the intersections between the tooth flank surfaces of the teeth and the respective end face of the workpiece following the initial machining operation, i.e. at the flank edges of the teeth at the opposite end faces of the workpiece. A subsequent finishing operation may therefore be required in order to chamfer the flank edges of the teeth at the opposite end faces of the workpiece and thereby remove said burrs and sharp edges.

WO 2022/013068 A1 discloses a method for chamfering flank edges of teeth on a cylindrical toothed workpiece at an end face of the workpiece by means of a milling tool, wherein the workpiece and the milling tool are rotated with a predefined relationship between the speed of rotation of the milling tool and the speed of rotation of the workpiece, while keeping the axis of rotation of the milling tool in parallel with the central axis of the workpiece. In the method according to WO 2022/013068 A1, the flank edges are chamfered in such a manner that a first flank edge on a tooth is chamfered in a direction from the tooth tip to the tooth root of the tooth, whereupon an opposite second flank edge on an adjacent tooth is chamfered in a direction from the tooth root to the tooth tip of the tooth. The milling tool disclosed in WO 2022/013068 A1 is configured to be moved into contact with a forwardly facing end face of the workpiece. When the flank edges at a forwardly facing first end face of the workpiece have been chamfered, the workpiece has to be repositioned in the workpiece holder to make the opposite second end face of the workpiece face forwards towards the milling tool before proceeding with a chamfering of the flank edges at this second end face of the workpiece.

### OBJECT OF THE INVENTION

The object of the present invention is to provide a milling tool of the above-mentioned type that has a new and favourable design.

### SUMMARY OF THE INVENTION

According to a first aspect of the invention, said object is achieved by means of a milling tool having the features defined in claim 1.

The milling tool according to the first aspect of the invention comprises an elongated tool body, which at a rear end has a rear part configured for attachment to a machine and at a distance from the rear part has a cutting part provided with cutting edges, wherein the tool body comprises an elongated shank part, which carries the cutting part and extends from the cutting part towards the rear part. The shank part has a front end facing the cutting part, an opposite rear end and a peripheral surface extending around the shank part between the rear end and the front end thereof, wherein the shank part has a longitudinal central axis that coincides with an axis of rotation of the tool body.

The cutting part is provided with at least one pair of cutting edges consisting of a first cutting edge facing away from the rear part and a second cutting edge facing the rear part and located closer to the rear part than the first cutting edge, wherein:
the first cutting edge has a rear end and an opposite front end, the rear end of the first cutting edge being located closer to the rear part of the tool body than the front end of the first cutting edge, wherein the front end of the first cutting edge is located closer to the axis of rotation than the rear end of the first cutting edge and the distance between the first cutting edge and the axis of rotation is gradually increasing as seen in a direction along the first cutting edge from the front end thereof to the rear end thereof, and
the second cutting edge has a front end and an opposite rear end, the rear end of the second cutting edge being located closer to the rear part of the tool body than the front end of the second cutting edge, wherein the rear end of the second cutting edge is located at a longer distance from the axis of rotation than the radially outermost part of the peripheral surface of the shank part, and wherein the rear end of the second cutting edge is located closer to the axis of rotation than the front end of the second cutting edge and the distance between the second cutting edge and the axis of rotation is gradually increasing as seen in a direction along the second cutting edge from the rear end thereof to the front end thereof.

Furthermore, the cutting part has an extension in the axial direction of the tool body limited to an area between a first plane that extends perpendicularly to the axis of rotation and intersects the rear end of the second cutting edge and a second plane that extends perpendicularly to the axis of rotation and intersects the front end of the first cutting edge. According to a first alternative, the cutting part constitutes an axially foremost part of the tool body, i.e. the part of the tool body that is most distant from the rear part of the tool body. According to a second alternative, the tool body comprises a front part that projects from the cutting part on the side thereof facing away from the rear part, wherein the front end of the first cutting edge is located at a longer distance from the axis of rotation than a radially outermost part of this front part.

The design of the tool body with the elongated shank part between the cutting part and the rear part, the arrangement of the first and second cutting edges on the cutting part as defined above and the position of the second cutting edge in relation to the peripheral surface of the shank part as defined above, imply that the milling tool may be used for chamfering the flank edges of internal or external teeth on a cylindrical toothed workpiece at both end faces of the workpiece without requiring any repositioning of the workpiece. The above-mentioned first cutting edge may be used for chamfering the flank edges of the teeth on a toothed workpiece at an end face of the workpiece facing away from a workpiece holder that carries the workpiece, and the above-mentioned second cutting edge may be used for chamfering the flank edges of the teeth on the workpiece at the opposite end face of the workpiece.

The above-mentioned internal or external teeth on the workpiece are preferably gear teeth or spline teeth, preferably of module 2-12.

The radial distance between the rear end of the second cutting edge and the radially outermost part of the peripheral surface of the shank part has to be suitably adapted to the tooth depth of the teeth on the toothed workpiece to be machined and is preferably 2-40 mm, more preferably 6-30 mm. Said radial distance is with advantage larger than the tooth depth but may as an alternative, in view of the extension of the second cutting edge in radial direction, be somewhat smaller that the tooth depth. In the case when the tool body comprises a front part that projects from the cutting part on the side thereof facing away from the rear part, the radial distance between the front end of the first cutting edge and a radially outermost part of a peripheral surface of this front part is preferably 2-40 mm, more preferably 6-30 mm, and preferably but not necessarily equal to the radial distance between the rear end of the second cutting edge and the radially outermost part of the peripheral surface of the shank part.

According to an embodiment of the invention, the first cutting edge extends substantially rectilinearly in a third plane that contains the axis of rotation, and the second cutting edge extends substantially rectilinearly in a fourth plane that contains the axis of rotation. The fourth plane may be angularly offset from the third plane with respect to the axis of rotation. However, the fourth plane preferably coincides with the third plane. The first and second cutting edges have such an inclination in the third plane and the fourth plane, respectively, that an extension of the first cutting edge forms a first angle with the axis of rotation and an extension of the second cutting edge forms a second angle with the axis of rotation. The first and second cutting edges may have such inclinations that the first and second angles differ from each other. However, the first and second cutting edges preferably have such inclinations that first and second angles are substantially equal. The first and second angles are with advantage larger than or equal to 20° and smaller than 90°, preferably 30-80°.

Another embodiment of the invention is characterized in:
that the first cutting edge is formed at an intersection between a first surface on the cutting part and a second surface on the cutting part, wherein the first surface and the second surface are mirror symmetrical to each other with respect to the above-mentioned third plane; and
that the second cutting edge is formed at an intersection between a third surface on the cutting part and a fourth surface on the cutting part, wherein the third surface and the fourth surface are mirror symmetrical to each other with respect to the above-mentioned fourth plane.

The cutting performance of each cutting edge will hereby be the same in both directions of rotation of the milling tool. When chamfering is performed by the first cutting edge, said first surface has the function of a rake face and said second surface has the function of a clearance face when the milling tool is rotated in one direction of rotation, whereas the first surface has the function of a clearance face and the second surface has the function of a rake face when the direction of rotation is changed. When chamfering is performed by the second cutting edge, said third surface has the function of a rake face and said fourth surface has the function of a clearance face when the milling tool is rotated in one direction of rotation, whereas the third surface has the function of a clearance face and the fourth surface has the function of a rake face when the direction of rotation is changed.

The first cutting edge and the second cutting edge are preferably mirror symmetrical to each other with respect to a plane of symmetry that extends halfway between the first and second cutting edges perpendicularly to the axis of rotation.

According to another embodiment of the invention, the cutting part comprises a holder arm that projects in radial direction in relation to the axis of rotation beyond the radially outermost part of the peripheral surface of the shank part, wherein the holder arm has an inner end facing the axis of rotation, i.e. a radially inner end, and an opposite outer end, i.e. a radially outer end, and wherein the first and second cutting edges are arranged on the holder arm at the outer end thereof. As an alternative, the cutting part may comprise a disc-shaped holder that projects in radial direction in relation to the axis of rotation beyond the radially outermost part of the peripheral surface of the shank part, wherein the first and second cutting edges are arranged on the disc-shaped holder at an outer periphery thereof.

According to another embodiment of the invention, the first and second cutting edges form part of a cutting insert that is releasably mounted to an insert seat provided at the outer end of said holder arm or alternatively at the outer periphery of said disc-shaped holder. Hereby, a cutting insert may easily be replaced by a new one when any of the first and second cutting edges has been worn out.

According to another embodiment of the invention, the cutting part comprises a base, which carries the holder arm and which is slidably mounted to the shank part at the front end thereof so as to be linearly slidable in relation to the shank part perpendicularly to the axis of rotation and in a longitudinal direction of the holder arm, wherein the base is lockable to the shank part in different sliding positions in relation to the shank part to thereby allow an adjustment of the radial distance between the first cutting edge and the axis of rotation and the radial distance between the second cutting edge and the axis of rotation.

The shank part is preferably rod-shaped and is to be longer than the length of the workpiece, i.e. longer than the axial distance between the two opposite end faces of the workpiece. The shank part may for instance have a length of 25-500 mm, preferably 50-200 mm, more preferably 100-150 mm.

According to another embodiment of the invention, the cutting part is detachably mounted to the shank part at the front end thereof. In this case, it is for instance possible to provide several cutting parts with holder arms of different lengths to thereby allow the milling tool to be easily adapted to the tooth depth of the teeth on the toothed workpiece to be machined by mounting of a cutting part with a holder arm of a suitable length to the shank part.

Further advantageous features of the milling tool according to the present invention will appear from the description following below.

According to a second aspect of the invention, said object is achieved by means of a method having the features defined in claim 13.

The method according to the second aspect of the invention is a method for chamfering flank edges of internal or external teeth on a cylindrical toothed workpiece at a first end face of the workpiece and at an opposite second end face of the workpiece, wherein each tooth on the workpiece has a tooth tip, a tooth root, a first tooth flank surface extending between the tooth tip and the tooth root on a first side of the tooth and a second tooth flank surface extending between the tooth tip and the tooth root on an opposite second side of the tooth, a first flank edge being formed at an intersection between the first tooth flank surface and the first end face of the workpiece, a second flank edge being formed at an intersection between the second tooth flank surface and the first end face of the workpiece, a third flank edge being formed at an intersection between the first tooth flank surface and the second end face of the workpiece and a fourth flank edge being formed at an intersection between the second tooth flank surface and the second end face of the workpiece, wherein the workpiece is attached to a machine and rotatable by the machine about a central axis of the workpiece and wherein the chamfering is performed by means of a milling tool according to the invention, which is attached to the machine and rotatable by the machine about the axis of rotation of the tool body and moveable by the machine in relation to the workpiece in the axial direction of the workpiece and in different directions in a plane perpendicular to the central axis of the workpiece with the axis of rotation of the tool body in parallel with the central axis of the workpiece, the method comprising the following steps:
a) positioning the milling tool in a first predefined position in relation to the workpiece with the axis of rotation of the tool body in parallel with the central axis of the workpiece and with the cutting part of the tool body adjacent to the first end face of the workpiece and with one of the first and second cutting edges of the at least one pair of cutting edges facing this first end face;
b) rotating the milling tool about the axis of rotation of the tool body and simultaneously rotating the workpiece about its central axis with a predefined relationship between the speed of rotation of the milling tool and the speed of rotation of the workpiece, while keeping the axis of rotation of the tool body in parallel with the central axis of the workpiece and moving the milling tool along a predefined path in relation to the workpiece such that the cutting edge or cutting edges facing the first end face of the workpiece chamfers the first and second flank edges of the teeth on the workpiece;
c) moving the milling tool in relation to the workpiece to move the cutting edge or cutting edges facing the first end face of the workpiece out of contact with the workpiece;
d) moving the milling tool in relation to the workpiece to a second predefined position with the axis of rotation of the tool body in parallel with the central axis of the workpiece and with the cutting part of the tool body adjacent to the opposite second end face of the workpiece and with the other one of the first and second cutting edges of the at least one pair of cutting edges facing this second end face; and
e) rotating the milling tool about the axis of rotation of the tool body and simultaneously rotating the workpiece about its central axis with a predefined relationship between the speed of rotation of the milling tool and the speed of rotation of the workpiece, while keeping the axis of rotation of the tool body in parallel with the central axis of the workpiece and moving the milling tool along a predefined path in relation to the workpiece such that the cutting edge or cutting edges facing the second end face of the workpiece chamfers the third and fourth flank edges of the teeth on the workpiece.

With this method, the milling tool chamfers the flank edges of internal or external teeth on the cylindrical toothed workpiece at both end faces of the workpiece without requiring any repositioning of the workpiece. Thus, the workpiece may remain clamped to a suitable workpiece holder of the machine in one and the same orientation during the entire chamfering process, which saves time. The above-mentioned first cutting edge on the milling tool is used for chamfering the flank edges of the teeth on the workpiece at the end face of the workpiece that faces away from the workpiece holder that carries the workpiece in a rotatable manner, and the above-mentioned second cutting edge on the milling tool is used for chamfering the flank edges of the teeth on the workpiece at the opposite end face of the workpiece. The chamfering process may start with a chamfering of the flank edges at the end face of the workpiece that faces away from the workpiece holder and thereafter proceed with a chamfering of the flank edges at the end face of the workpiece that faces the workpiece holder. As an alternative, the chamfering process may start with a chamfering of the flank edges at the end face of the workpiece that faces the workpiece holder and thereafter proceed with a chamfering of the flank edges at the end face of the workpiece that faces away from the workpiece holder.

According to an embodiment of the invention, said predefined path for the movement of the milling tool in relation to the workpiece in step b comprises at least one part in which the milling tool is moved in its axial direction to thereby move the cutting edge or cutting edges facing the first end face of the workpiece in a direction towards this first end face, and/or said predefined path for the movement of the milling tool in relation to the workpiece in step e comprises at least one part in which the milling tool is moved in its axial direction to thereby move the cutting edge or cutting edges facing the second end face of the workpiece in a direction towards this second end face.

According to another embodiment of the invention, said predefined path for the movement of the milling tool in relation to the workpiece in step b comprises at least one part in which the distance between the axis or rotation of the tool body and the central axis of the workpiece is changed, and/or said predefined path for the movement of the milling tool in relation to the workpiece in step e comprises at least one part in which the distance between the axis or rotation of the tool body and the central axis of the workpiece is changed. The change of the distance between the axis or rotation of the tool body and the central axis of the workpiece may be achieved by moving the milling tool in directions perpendicular to the axis of rotation of the tool body and/or by moving the workpiece in directions perpendicular to the central axis of the workpiece.

The predefined path for the movement of the milling tool in relation to the workpiece in step b and/or step e may of course also comprise one or more parts in which the milling tool is moved in its axial direction at the same time as the distance between the axis or rotation of the tool body and the central axis of the workpiece is changed.

According to another embodiment of the invention:
the first flank edges and the second flank edges of the teeth on the workpiece are each chamfered in a machining direction from the tooth root to the tooth tip of the associated tooth in step b, and
the third flank edges and the fourth flank edges of the teeth on the workpiece are each chamfered in a machining direction from the tooth root to the tooth tip of the associated tooth in step e.

Thus, the chamfering of each flank edge is started at the deepest part of the gap between two teeth, i.e. at the so-called bottom land or tooth root surface, and ended at the tooth tip of the associated tooth. It has turned out that burr formation may occur at the tooth root area when chamfering of a flank edge is performed in a machining direction from the tooth tip to the tooth root, especially with a cutting edge that has been in use for a while and has started to get worn. It has also turned out that such burr formation is avoided when the chamfering of a flank edge is performed in the opposite machining direction from the tooth root to the tooth tip. Thus, a chamfering of each flank edge of the teeth on the workpiece in a machining direction from the tooth root to the tooth tip results in improved quality of the chamfers produced on the flank edges.

In order to achieve a chamfering of each one of the first and second flank edges of the teeth on the workpiece in a machining direction from the tooth root to the tooth tip, according to a further one embodiment, step b comprises the following substeps:
b1) chamfering the first flank edges of the teeth on the workpiece, while rotating the workpiece about its central axis in a first direction of rotation with the second tooth flank surfaces as leading tooth flank surfaces and with the first tooth flank surfaces as trailing tooth flank surfaces, and while rotating the milling tool about the axis of rotation of the tool body in the same direction of rotation as the workpiece when the first flank edges that are being chamfered are flank edges of internal teeth on the workpiece or in an opposite direction of rotation when the first flank edges that are being chamfered are flank edges of external teeth on the workpiece, and
b2) chamfering the second flank edges of the teeth on the workpiece, while rotating the workpiece about its central axis in a second direction of rotation opposite to the first direction of rotation, and while rotating the milling tool about the axis of rotation of the tool body in the same direction of rotation as the workpiece when the second flank edges that are being chamfered are flank edges of internal teeth on the workpiece or in an opposite direction of rotation when the second flank edges that are being chamfered are flank edges of external teeth on the workpiece.

In this description and the subsequent claims, the expression “leading tooth flank surfaces” refers to the tooth flank surfaces that are facing in the direction of rotation, i.e. forwards, when the toothed workpiece is rotated about its central axis, whereas the expression “trailing tooth flank surfaces” refers to the tooth flank surfaces that are facing in the opposite direction, i.e. backwards, when the toothed workpiece is rotated about its central axis.

In order to achieve a chamfering of each one of the third and fourth flank edges of the teeth on the workpiece in a machining direction from the tooth root to the tooth tip, according to a further one embodiment, step e comprises the following substeps:
e1) chamfering the third flank edges of the teeth on the workpiece, while rotating the workpiece about its central axis in the first direction of rotation, and while rotating the milling tool about the axis of rotation of the tool body in the same direction of rotation as the workpiece when the third flank edges that are being chamfered are flank edges of internal teeth on the workpiece or in an opposite direction of rotation when the third flank edges that are being chamfered are flank edges of external teeth on the workpiece, and
e2) chamfering the fourth flank edges of the teeth on the workpiece, while rotating the workpiece about its central axis in the second direction of rotation, and while rotating the milling tool about the axis of rotation of the tool body in the same direction of rotation as the workpiece when the fourth flank edges that are being chamfered are flank edges of internal teeth on the workpiece or in an opposite direction of rotation when the fourth flank edges that are being chamfered are flank edges of external teeth on the workpiece.

The above-mentioned substeps are preferably carried out in the following order: b1-b2-e1-e2, wherein the direction of rotation of the milling tool and the workpiece is reversed between substeps b1 and b2 and between substeps e1 and e2. However, these substeps may as an alternative be carried out in the following order: b1-e1-e2-b2, wherein the direction of rotation of the milling tool and the workpiece is reversed only between substeps e1 and e2.

According to a third aspect, the invention relates to a computer based program having instructions which when executed by a CNC machine causes the CNC machine to perform the steps according to any of the above described methods. Said computer program, or computer program product, may be included in a CAM-software product, i.e. a software for computer-aided manufacturing. Said computer program may be in the form of a computer readable medium such as a USB-stick, a CD-ROM or a data stream.

Further advantageous features of the method according to the present invention will appear from the description following below.

### BRIEF DESCRIPTION OF THE DRAWINGS

With reference to the appended drawings, a specific description of embodiments of the invention cited as examples follows below. In the drawings:

FIG. 1 is a perspective view of a milling tool according to an embodiment of the present invention,

FIG. 2 is a lateral view of the milling tool of FIG. 1,

FIG. 3 is a front view of the milling tool of FIG. 1,

FIGS. 4a and 4b are exploded perspective views from different directions of a part of the milling tool of FIG. 1,

FIG. 5 is a rear view of a cutting part included in the milling tool of FIG. 1,

FIG. 6 is a lateral view of the cutting part of FIG. 5,

FIG. 7 is a perspective view of the cutting part of FIG. 5,

FIG. 8 is a planar view of the cutting part of FIG. 5,

FIG. 9a is a perspective view of the milling tool of FIG. 1 and an internally toothed workpiece, as seen with the milling tool in a position for chamfering flank edges at a first end face of the workpiece,

FIG. 9b is a front view of the milling tool and workpiece of FIG. 9a,

FIGS. 10a and 10b are perspective views from different directions of the milling tool and workpiece of FIG. 9a, as seen with the milling tool in a position for chamfering flank edges at an opposite second end face of the workpiece,

FIG. 10c is a front view of the milling tool and workpiece of FIGS. 10a and 10b,

FIG. 11 is a perspective view in larger scale of a part of the internally toothed workpiece of FIG. 9a,

FIG. 12 is a font view in larger scale of a part of the internally toothed workpiece of FIG. 9a,

FIG. 13 is a partly cut lateral view of the milling tool and a part of the workpiece of FIG. 9a,

FIGS. 14a-14e are illustrations of different stages in a process of chamfering flank edges on an internally toothed workpiece by means of the milling tool of FIG. 1,

FIG. 15a is a perspective view of the milling tool of FIG. 1 and an externally toothed workpiece, as seen with the milling tool in a position for chamfering flank edges at a first end face of the workpiece,

FIG. 15b is a front view of the milling tool and workpiece of FIG. 15a,

FIGS. 16a and 16b are perspective views from different directions of the milling tool and workpiece of FIG. 15a, as seen with the milling tool in a position for chamfering flank edges at an opposite second end face of the workpiece,

FIG. 16c is a front view of the milling tool and workpiece of FIGS. 16a and 16b, and

FIG. 17 is a lateral view of a milling tool according to an alternative embodiment of the invention.

### DETAILED DESCRIPTION OF EMBODIMENTS OF THE INVENTION

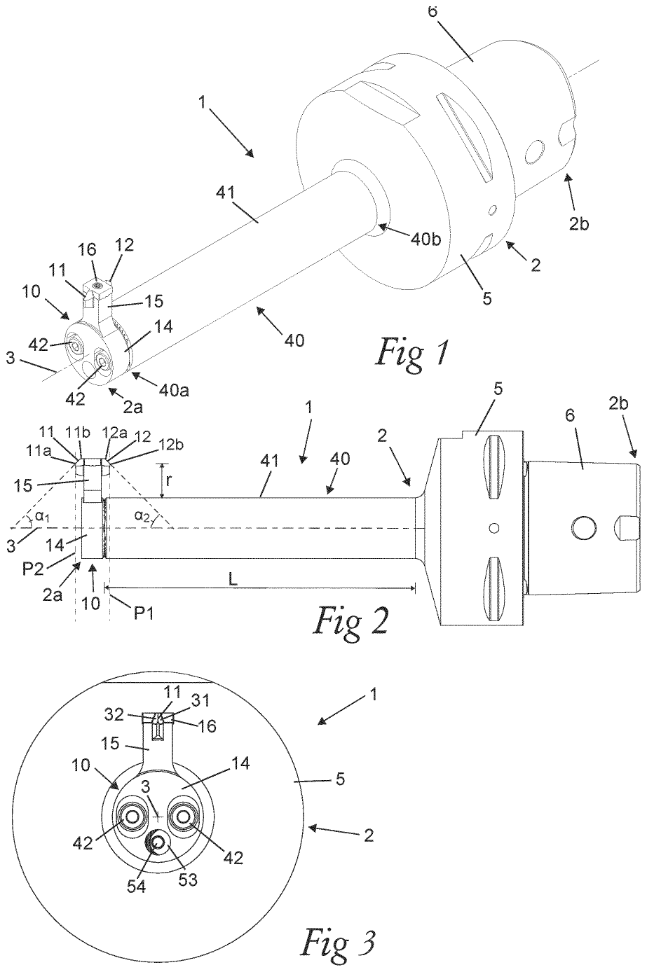

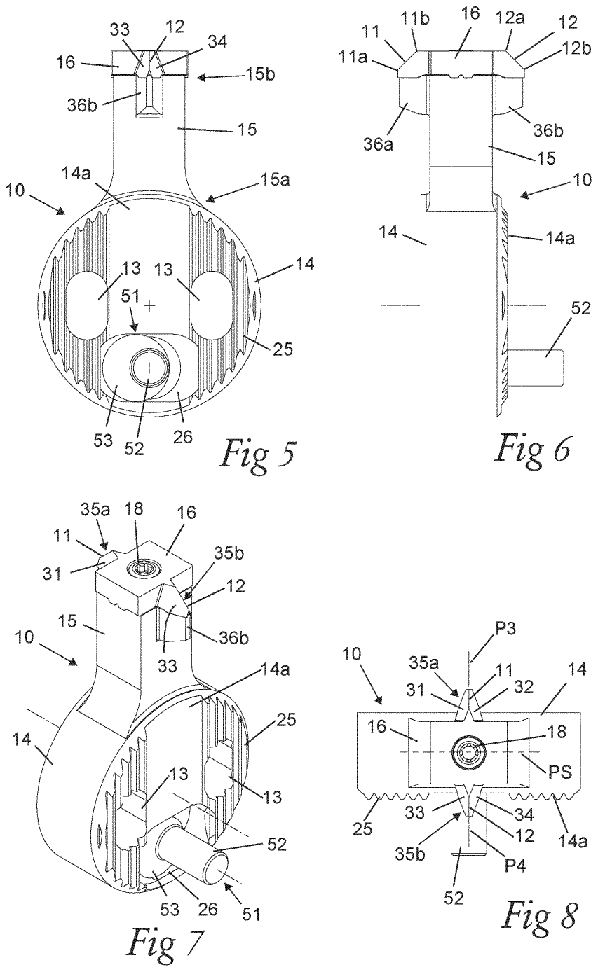

An embodiment of a milling tool 1 according to the present invention is illustrated in FIGS. 1-8. The milling tool 1 is to be used for chamfering flank edges of internal or external teeth on a cylindrical toothed workpiece at opposite end faces of the workpiece. The milling tool 1 comprises an elongated tool body 2, which is configured to be rotated about an axis of rotation 3. The tool body 2 has a front end 2a and an opposite rear end 2b. In the illustrated embodiment, a collar 5 is provided on the tool body 2. A rear part 6 of the tool body 2 located between the collar 5 and the rear end 2b forms a connection member, through which the tool body 2 is mountable, directly or via an intermediate tool holder, to a rotating spindle or the similar of a machine, for instance a milling machine. In the embodiments illustrated in the figures, the rear part 6 is Coromant Capto® of the size C8. Other Coromant Capto® sizes that may be used are sizes C3-C10. The rear part 6 may be any other connection member suitable for such a purpose, such as HSK.

The tool body 2 comprises a cutting part 10, which is located at a distance from the rear part 6 and which is provided with cutting edges 11, 12. The tool body 2 further comprises an elongated shank part 40, which carries the cutting part 10 and extends from the cutting part 10 towards the rear part 6. The shank part 40 has a front end 40a facing the cutting part 10 and an opposite rear end 40b facing the collar 5 and the rear part 6. The cutting part 10 is mounted to the shank part 40 at the front end 40a thereof. The shank part 40 has a peripheral surface 41, which extends around the shank part 40 between the rear end 40b and the front end 40a thereof. The shank part 40 has a longitudinal central axis that coincides with an axis of rotation 3 of the tool body 2.

The cutting part 10 is provided with one pair of cutting edges consisting of a first cutting edge 11, which faces away from the rear part 6 of the tool body, and a second cutting edge 12, which faces the rear part 6 of the tool body and which is located closer to the rear part 6 than the first cutting edge 11. Thus, the first cutting edge 11 is more distant from the rear part 6 of the tool body than the second cutting edge 12. Each one of the first and second cutting edges 11, 12 has a front end 11a, 12a and an opposite rear end 11b, 12b. The rear end 11b of the first cutting edge 11 is located closer to the rear part 6 of the tool body than the front end 11a of the first cutting edge and the rear end 12b of the second cutting edge 12 is located closer to the rear part 6 of the tool body than the front end 12a of the second cutting edge. The front end 11a of the first cutting edge 11 is located closer to the axis of rotation 3 than the rear end 11b of the first cutting edge and the distance between the first cutting edge 11 and the axis of rotation 3 is gradually increasing as seen in a direction along the first cutting edge 11 from the front end 11a thereof to the rear end 11b thereof, as illustrated in FIGS. 2 and 6. The rear end 12b of the second cutting edge 12 is located closer to the axis of rotation 3 than the front end 12a of the second cutting edge and the distance between the second cutting edge 12 and the axis of rotation 3 is gradually increasing as seen in a direction along the second cutting edge 12 from the rear end 12b thereof to the front end 12a thereof. Furthermore, the rear end 12b of the second cutting edge 12 is located at a longer distance from the axis of rotation 3 than the radially outermost part of the peripheral surface 41 of the shank part 40.

The cutting part 10 could also be provided with two or more pairs of cutting edges 11, 12 of the type described above.

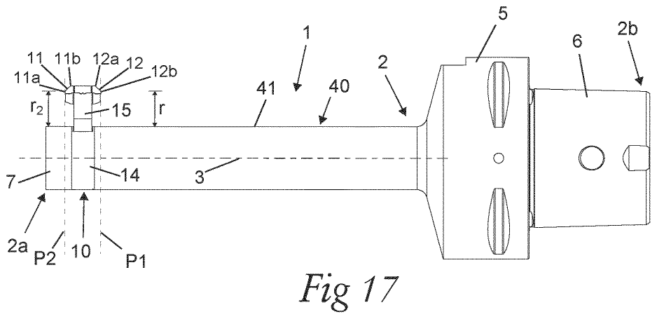

The cutting part 10 has an extension in the axial direction of the tool body 2 limited to an area between a first plane P1 (see FIG. 2) that extends perpendicularly to the axis of rotation 3 and intersects the rear end 12b of the second cutting edge 12 and a second plane P2 that extends perpendicularly to the axis of rotation 3 and intersects the front end 11a of the first cutting edge 11. In the embodiment illustrated in FIGS. 1-8, the tool body 2 does not have any part that extends axially beyond the cutting part 10. Thus, in this case, the cutting part 10 constitutes the axially foremost part of the tool body 2, i.e. the part of the tool body 2 that is most distant from the rear part 6. The tool body 2 may as an alternative also comprise a front part 7 that is connected to the cutting part 10 and projects from the cutting part on the side thereof facing away from the rear part 6, as illustrated in FIG. 17. In this case, the front end 11a of the first cutting edge 11 is to be located at a longer distance from the axis of rotation 3 than a radially outermost part of a peripheral surface of said front part 7.

The radial distance r between the rear end 12b of the second cutting edge 12 and the radially outermost part of the peripheral surface 41 of the shank part 40 is preferably 2-40 mm, more preferably 6-30 mm. In the embodiment illustrated in FIG. 17, radial distance r2 between the front end 11a of the first cutting edge 11 and the radially outermost part of the peripheral surface of the front part 7 is preferably 2-40 mm, more preferably 6-30 mm.

In the illustrated embodiments, the shank part 40 is rod-shaped and has the form of a right circular cylinder. However, the shank part 40 may also have any other suitable shape. The shank part 40 has a length L of 25-500 mm, preferably 50-200 mm, more preferably 100-150 mm.

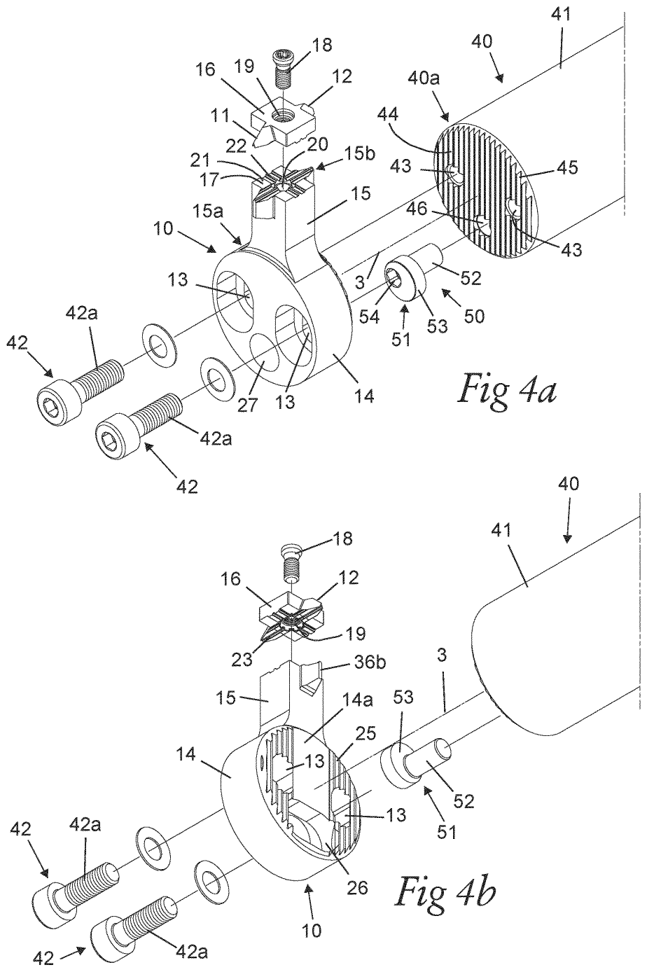

The cutting part 10 may be permanently fixed to the shank part 40. However, in the embodiment illustrated in FIGS. 1-8, the cutting part 10 is detachably mounted to the shank part 40 at the front end 40a thereof by means of fastening elements 42 in the form of two screws, which extend through a respective through hole 13 in the cutting part 10 and are engaged in a respective threaded hole 43 (see FIG. 4a) provided in a front end face 44 of the shank part 40.

In the illustrated embodiments, the cutting part 10 comprises a base 14, through which the cutting part 10 is mounted to the shank part 40, and holder arm 15, which is fixed to the base 14 and projects from the base 14 in radial direction in relation to the axis of rotation 3 beyond the radially outermost part of the peripheral surface 41 of the shank part 40. The holder arm 15 has an inner end 15a facing the axis of rotation 3 and an opposite outer end 15b. The holder arm 15 is fixed to the base 14 at its inner end 15a and the first and second cutting edges 11, 12 are arranged on the holder arm 15 at the outer end 15b thereof. In the illustrated embodiments, the first and second cutting edges 11, 12 form part of a cutting insert 16 that is releasably mounted to an insert seat 17 provided at the outer end 15b of the holder arm 15. The illustrated cutting insert 16 is releasably fixed to the insert seat 17 by means of a fastening element 18 in the form of a screw, which extends through a through hole 19 in the cutting insert 16 and is engaged in a threaded hole 20 (see FIG. 4a) in a support surface 21 in the insert seat 17. The support surface 21 is with advantage provided with splines 22 or the similar configured for positive mechanical engagement with corresponding splines 23 on an underside of the cutting insert 16 in order to ensure a correct positioning of the cutting insert 16 in the insert seat 17 and prevent the cutting insert 16 from moving in relation to the support surface 21 when properly mounted to the insert seat 17.

The base 14 and the shank part 40 are with advantage formed as separate components, wherein the base 14 may be detachably mounted the shank part 40. However, the base 14 and the shank part 40 may as an alternative be formed in one piece. In a corresponding manner, the front part 7 and the base 14 included in the milling tool 1 illustrated in FIG. 17 may be formed in one piece or formed as separate components that are mounted to each other.

In the embodiment illustrated in FIGS. 1-8, the base 14 is slidably mounted to the shank part 40 at the front end 40a thereof so as to be linearly slidable in relation to the shank part 40 perpendicularly to the axis of rotation 3 and in the longitudinal direction of the holder arm 15, wherein the base 14 is lockable to the shank part 40 in different sliding positions in relation to the shank part 40 to thereby allow an adjustment of the radial distance between the first cutting edge 11 and the axis of rotation 3 and the radial distance between the second cutting edge 12 and the axis of rotation 3.

Thus, by adjustment of the position of the base 14 in relation to the skank part 40, it will be possible to adjust the above-mentioned radial distance r between the rear end 12b of the second cutting edge 12 and the radially outermost part of the peripheral surface 41 of the shank part 40. In the illustrated example, a rear face 14a of the base 14 is provided with mutually parallel splines 25, which extend in parallel with a longitudinal axis of the holder arm 15 and which are in slidable engagement with corresponding splines 45 provided on the front end face 44 of the shank part 40 in order to allow the base 14 to slide in the desired direction in relation to the shank part 40 during the adjustment of the sliding position of the base 14 in relation to the shank part 40.

The milling tool 1 illustrated in FIGS. 1-8 comprises an adjustment mechanism 50, by means of which the sliding position of the base 14 in relation to the shank part 40 is adjustable. Thus, the exact positioning of the base 14 along the splines 45 on the front end face 44 of the shank part 40 is adjustable by means of the adjustment mechanism 50. In the illustrated embodiment, the adjustment mechanism 50 comprises an adjustment element 51, which is configured to act between the base 14 and the shank part 40. This adjustment element 51 comprises a pin 52, which is rotatably received in a hole 46 provided in the front end face 44 of the shank part 40, and a head 53, which is fixed to the pin 52 and rotatably received in a recess 26 provided in the rear face 14a of the base 14. The axis of rotation of the pin 52 is parallel to but offset from the axis of rotation of the head 53 such that a rotation of the head 53 in the recess 26 will effect a sliding movement of the base 14 in the longitudinal direction of the splines 25, 45. A socket 54 designed for releasable engagement with a torque tool (not shown) is provided in a front face of the head 53 so as to allow a torque tool to be connected to the head 53 when the head 53 is to be rotated in order to make it move the base 14 in the longitudinal direction of the splines 25, 45. The socket 54 is accessible through a hole 27 in the base 14. The above-mentioned through holes 13 for the fastening elements 42 are provided in the base 14. Each one of these trough holes 13 has an elongated cross-sectional shape with a longer axis extending substantially in the longitudinal direction of the splines 25 to thereby allow the base 14 to move perpendicularly to the shafts 42a of the fastening elements 42 in the longitudinal direction of the splines 45 on the front end face 44 of the shank part 40. The base 14 is lockable to the shank part 40 in a desired sliding position in relation to the shank part 40 by tightening of the fastening elements 42. The adjustment mechanism 50 may of course also be designed in any other suitable manner.

In the embodiment illustrated in FIGS. 1-8, the first cutting edge 11 extends substantially rectilinearly in a third plane P3 (see FIG. 8) that contains the axis of rotation 3 and the second cutting edge 12 extends substantially rectilinearly in a fourth plane P4 that contains the axis of rotation 3. The fourth plane P4 preferably coincides with the third plane P3, as illustrated in FIG. 8, but the third and fourth planes P3, P4 could as an alternative be angularly offset from each other with respect to the axis of rotation 3 of the tool body 2. The first cutting edge 11 has such an inclination in the third plane P3 that an extension of the first cutting edge 11 forms a first angle at (see FIG. 2) with the axis of rotation 3, and the second cutting edge 12 has such an inclination in the fourth plane P4 that an extension of the second cutting edge 12 forms a second angle α₂ with the axis of rotation. The first and second angles α₁, α₂ are preferably equal or at least substantially equal. The first angle α₁ and the second angle α₂ are larger than or equal to 20° and smaller than 90°, preferably 30-80°. In the illustrated embodiment, the first angle α₁ and the second angle α₂ are both approximately 45°.

In the embodiment illustrated in FIGS. 1-8, the first cutting edge 11 is formed at an intersection between a first surface 31 and a second surface 32 on the cutting insert 16 and the second cutting edge 12 is formed at an intersection between a third surface 33 and a fourth surface 34 on the cutting insert 16, wherein the first and second surfaces 31, 32 are mirror symmetrical to each other with respect to the third plane P3 and wherein the third and fourth surfaces 33, 34 are mirror symmetrical to each other with respect to the fourth plane P4. Furthermore, the first cutting edge 11 and the second cutting edge 12 are here mirror symmetrical to each other with respect to a plane of symmetry PS (see FIG. 8) that extends halfway between the first and second cutting edges 11, 12 perpendicularly to the axis of rotation 3 of the tool body 2. The first and second surfaces 31, 32 are inclined in relation to each other and diverge from each other in a direction from the first cutting edge 11 towards the axis or rotation 3, wherein the first and second surfaces 31, 32 form a first nose-shaped projection 35a on the cutting insert 16. In the corresponding manner, the third and fourth surfaces 33, 34 are inclined in relation to each other and diverge from each other in a direction from the second cutting edge 12 towards the axis or rotation 3, wherein the third and fourth surfaces 33, 34 form a second nose-shaped projection 35b on the cutting insert 16. A first projection 36a in provided on a first side of the holder arm 15 at the outer end 15b thereof in order to form a support for the first nose-shaped projection 35a on the cutting insert 16 and a second projection 36b in provided on an opposite second side of the holder arm 15 at the outer end 15b thereof in order to form a support for the second nose-shaped projection 35b on the cutting insert 16.

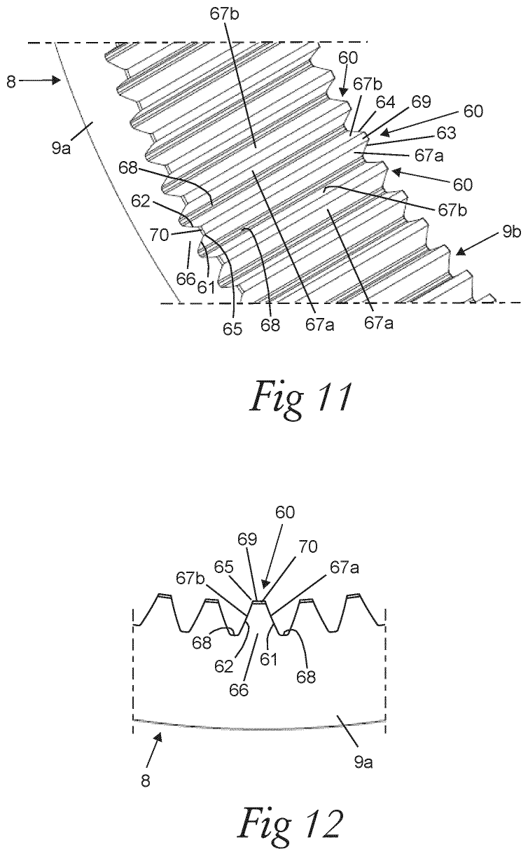

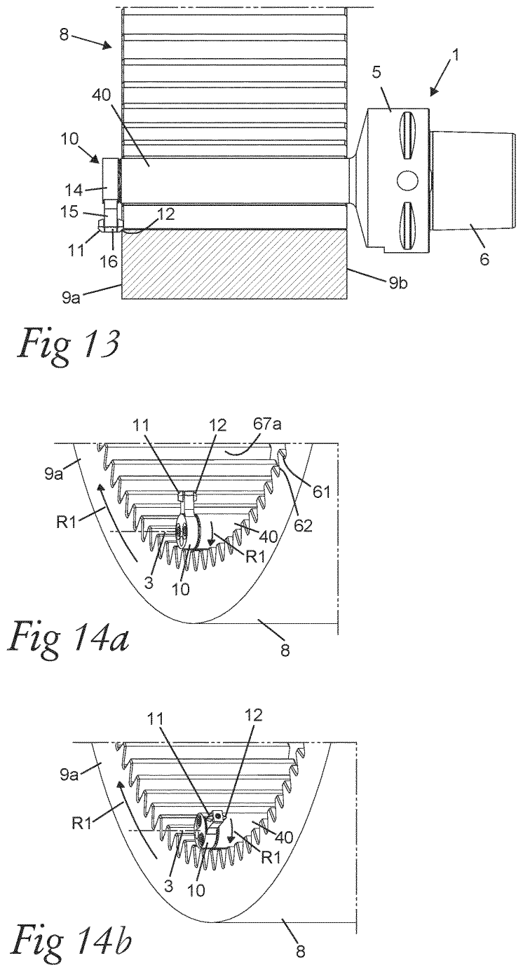

As mentioned above, the milling tool 1 is to be used for chamfering flank edges 61-64 (see FIGS. 11 and 12) of internal or external teeth 60 on a cylindrical toothed workpiece 8 at a first end face 9a of the workpiece and at an opposite second end face 9b of the workpiece. Each tooth 60 on the workpiece 8 has a tooth tip 65, a tooth root 66, a first tooth flank surface 67a extending between the tooth tip 65 and the tooth root 66 on a first side of the tooth and a second tooth flank surface 67b extending between the tooth tip 65 and the tooth root 66 on an opposite second side of the tooth. A first flank edge 61 is formed at an intersection between the first tooth flank surface 67a and the first end face 9a of the workpiece 8, a second flank edge 62 is formed at an intersection between the second tooth flank surface 67b and the first end face 9a of the workpiece 8, a third flank edge 63 is formed at an intersection between the first tooth flank surface 67a and the second end face 9b of the workpiece 8 and a fourth flank edge 64 is formed at an intersection between the second tooth flank surface 67b and the second end face 9b of the workpiece 8. A bottom land 68 is provided between the tooth roots 66 of every two adjacent teeth 60 and a top land 69 is provided at the tooth tip 65 of each tooth 60.

The edges 70 at the interfaces between the top land 69 of each tooth 60 on the workpiece 8 and the respective end face 9a, 9b of the workpiece are normally chamfered in a separate machining operation before the chamfering of the flank edges 61-64 is carried out by means of the milling tool 1.

During the performance of a chamfering operation with the use of the milling tool 1, the workpiece 8 is attached to a rotatable workpiece holder (not shown) of a machine and rotatable by the machine about a central axis 4 of the workpiece 8, wherein the milling tool 1 is attached to a rotatable tool holder (not shown) of the machine and rotatable by the machine about the axis of rotation 3 of the tool body 2 and moveable by the machine in relation to the workpiece 8 in the axial direction z of the workpiece 8 and in different directions in a plane x, y perpendicular to the central axis 4 of the workpiece 8 with the axis of rotation 3 of the tool body 2 in parallel with the central axis 4 of the workpiece 8. The speed of rotation of the workpiece 8, the speed of rotation of the milling tool 1 and the movements of the milling tool 1 in relation to the workpiece 8 are controlled in a program-controlled manner by means of an electronic control device (not shown).

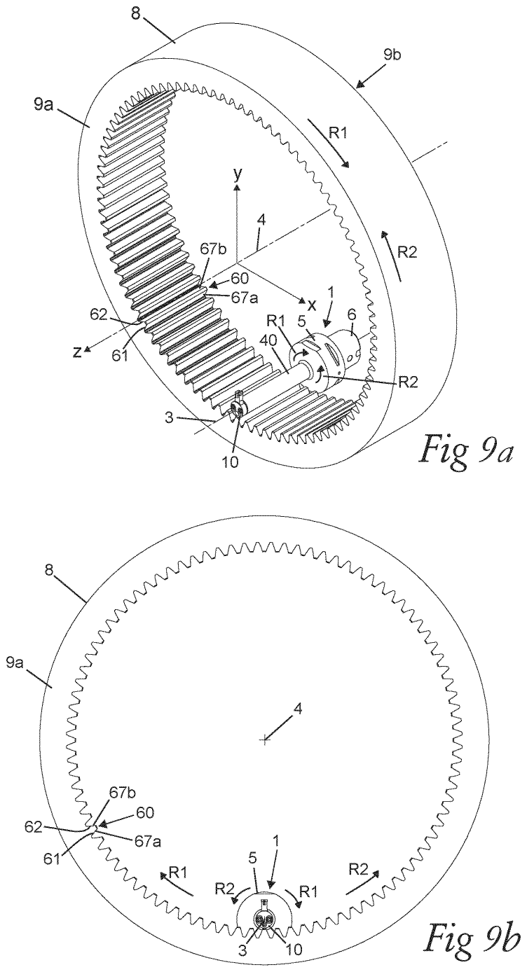

The workpiece holder and the tool holder of the machine are normally located opposite to each other with the tool holder facing the workpiece holder. In the examples illustrated in FIGS. 9-10 and FIGS. 15-16, the end face of the workpiece 8 referred to as the first end face 9a is facing the workpiece holder of the machine, wherein the opposite second end face 9b of the workpiece 8 is facing the tool holder of the machine.

The workpiece 8 is rotatable about its central axis 4 in a first direction of rotation R1 with the second tooth flank surfaces 67b of the teeth 60 on the workpiece as leading tooth flank surfaces and with the first tooth flank surfaces 67a of the teeth 60 on the workpiece as trailing tooth flank surfaces, and in a opposite second direction of rotation R2 with the first tooth flank surfaces 67a of the teeth 60 on the workpiece as leading tooth flank surfaces and with the second tooth flank surfaces 67b of the teeth 60 on the workpiece as trailing tooth flank surfaces.

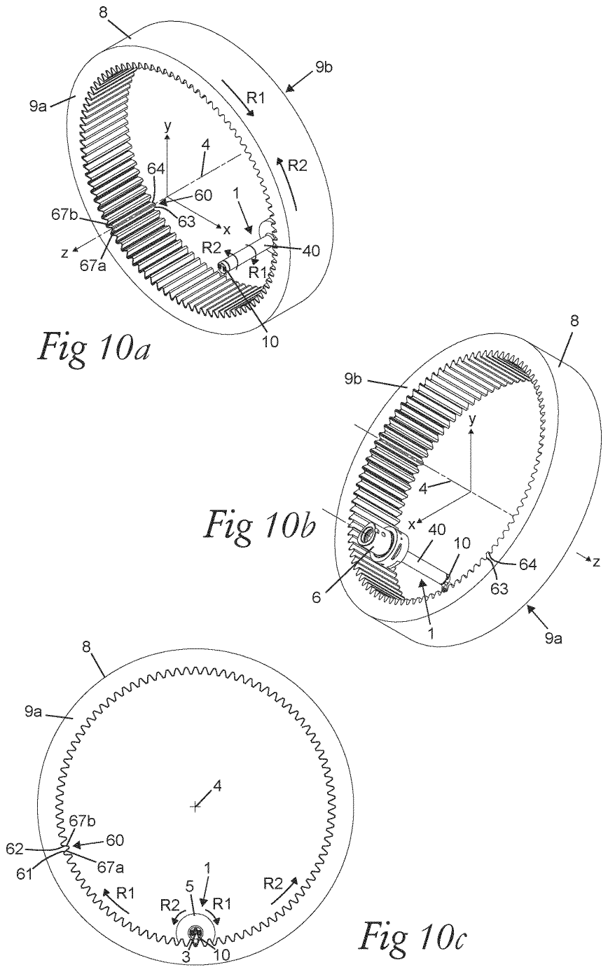

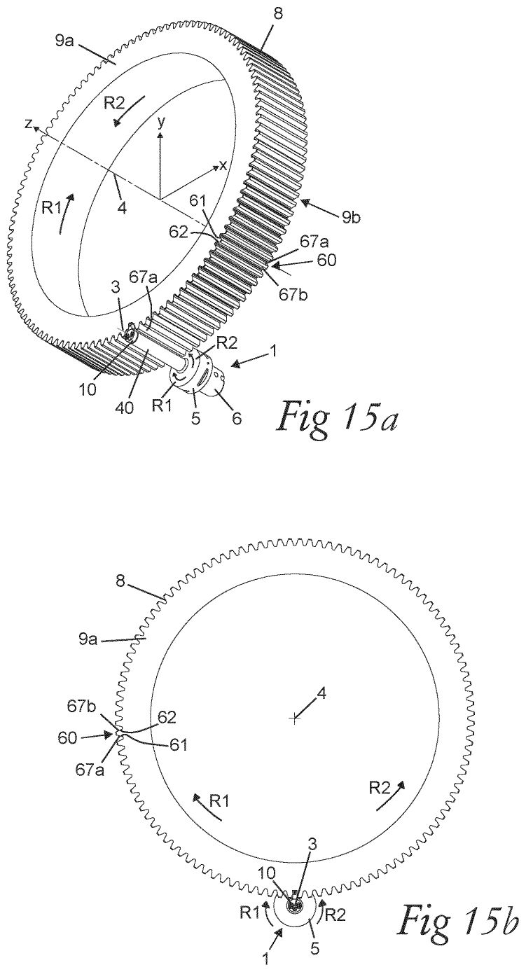

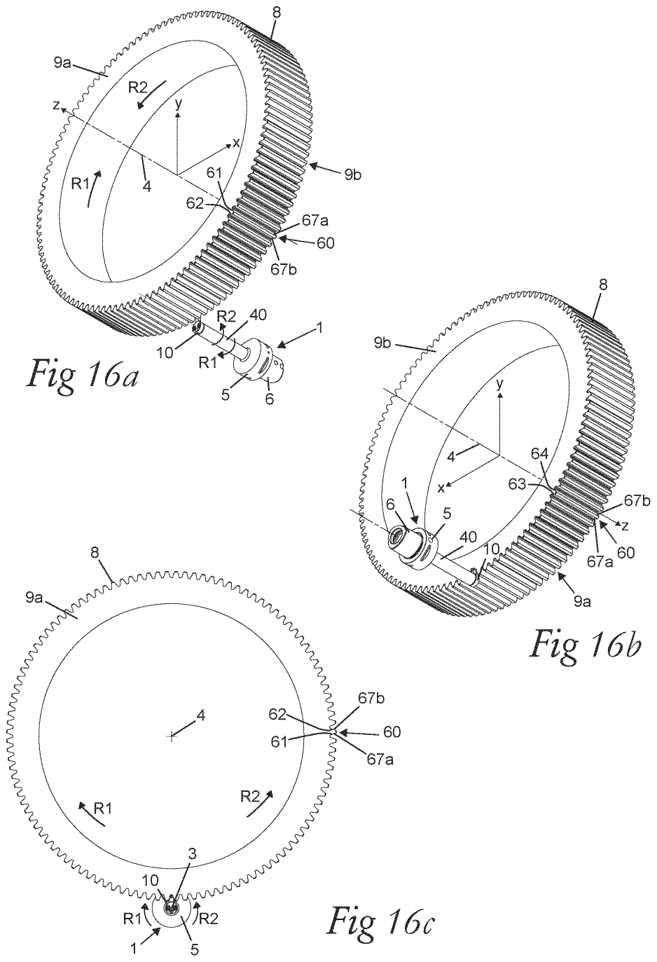

In order to perform a chamfering of all the flank edges 61-64 of the teeth 60 on the workpiece 8 by means of the milling tool 1, the following steps are performed:
a) the milling tool 1 is positioned in a first predefined position in relation to the workpiece 8 with the axis of rotation 3 of the tool body 2 in parallel with the central axis 4 of the workpiece 8 and with the cutting part 10 of the tool body 2 adjacent to the first end face 9a of the workpiece 8 and with the second cutting edge 12 facing this first end face 9a, as illustrated in FIGS. 9a and 15a;
b) the milling tool 1 is thereafter rotated about the axis of rotation 3 of the tool body 2 and the workpiece 8 is simultaneously rotated about its central axis 4 with a predefined relationship between the speed of rotation of the milling tool 1 and the speed of rotation of the workpiece 8, while keeping the axis of rotation 3 of the tool body 2 in parallel with the central axis 4 of the workpiece 8 and moving the milling tool 1 along a predefined path in relation to the workpiece 8 such that the second cutting edge 12 chamfers the first and second flank edges 61, 62 of the teeth 60 on the workpiece;
c) the milling tool 1 is thereafter moved in relation to the workpiece 8 to move the second cutting edge 12 out of contact with the workpiece 8;
d) the milling tool 1 is thereafter moved in relation to the workpiece 8 and positioned in a second predefined position in relation to the workpiece with the axis of rotation 3 of the tool body 2 in parallel with the central axis 4 of the workpiece 8 and with the cutting part 10 of the tool body 2 adjacent to the opposite second end face 9b of the workpiece 8 and with the first cutting edge 11 facing this second end face 9b, as illustrated in FIGS. 10a and 16a; and
e) the milling tool 1 is thereafter rotated about the axis of rotation 3 of the tool body 2 and the workpiece 8 is simultaneously rotated about its central axis 4 with a predefined relationship between the speed of rotation of the milling tool 1 and the speed of rotation of the workpiece 8, while keeping the axis of rotation 3 of the tool body 2 in parallel with the central axis 4 of the workpiece 8 and moving the milling tool 1 along a predefined path in relation to the workpiece 8 such that the first cutting edge 11 chamfers the third and fourth flank edges 63, 64 of the teeth 60 on the workpiece.

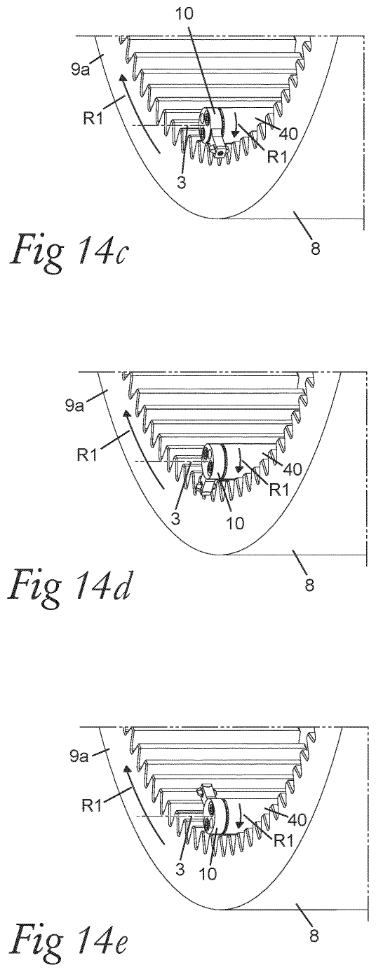

During the chamfering in the above-mentioned steps b and e, a part of the active one of the first and second cutting edges 11, 12 is rotated into a gap between two adjacent teeth 60 and is thereafter moved together with this gap in the direction of rotation of the workpiece 8 during a part of a revolution of the workpiece 8, while coming into cutting engagement with at least one section of one of the flank edges that are located on opposite sides of the gap, before being rotated out of the gap, as illustrated in FIGS. 14a-14e. Upon continued rotation of the milling tool 1, a part of the active one of the first and second cutting edges 11, 12 is rotated into a new gap between two other adjacent teeth 60 on the workpiece 8, and so on. By gradually moving the milling tool 1 in relation to the workpiece 8, during continued rotation of the milling tool 1 and the workpiece 8, such that the distance between the axis or rotation 3 of the tool body 2 and the central axis 4 of the workpiece 8 is changed, the active cutting edge 11, 12 may be made to come into cutting engagement with different sections of each flank edge that is being chamfered at different stages of the chamfering process until these flank edges have been chamfered along their entire extension.

The movement of the milling tool 1 in relation to the workpiece 8 in step b may start by first moving the milling tool 1 in its axial direction to thereby move the second cutting edge 12 in a direction towards the first end face 9a of the workpiece 8 such that the second cutting edge 12 makes contact with the workpiece 8 when the milling tool 1 rotates. The milling tool 1 may thereafter remain in this axial position in relation to the workpiece 8 during the remaining phase of step b to thereby achieve a chamfer of substantially constant width all along each flank edge that is being chamfered. However, the milling tool 1 may also be moved in its axial direction in relation to the workpiece 8 during at least a part of the remaining phase of step b to thereby achieve a chamfer of varying width along each flank edge that is being chamfered.

In the corresponding manner, the movement of the milling tool 1 in relation to the workpiece 8 in step e may start by first moving the milling tool 1 in its axial direction to thereby move the first cutting edge 11 in a direction towards the second end face 9b of the workpiece 8 such that the first cutting edge 11 makes contact with the workpiece 8 when the milling tool 1 rotates. The milling tool 1 may thereafter remain in this axial position in relation to the workpiece 8 during the remaining phase of step e to thereby achieve a chamfer of substantially constant width all along each flank edge that is being chamfered. However, the milling tool 1 may also be moved in its axial direction in relation to the workpiece 8 during at least a part of the remaining phase of step e to thereby achieve a chamfer of varying width along each flank edge that is being chamfered.

The relationship between the speed of rotation of the milling tool 1 and the speed of rotation of the workpiece 8 is to be so adapted that a part of the active cutting edge 11, 12 has entered the gaps between all teeth 60 on the workpiece 8 after a certain number of revolutions of the workpiece 8. In order to allow the active cutting edge to move in the same direction as the gap between two adjacent teeth 60 on the workpiece 8 with a part of the cutting edge received in the gap in question, the milling tool 1 has to be rotated about the axis of rotation 3 of the tool body 2 in the same direction of rotation as the workpiece 8 when flank edges 61-64 of internal teeth 60 on a workpiece are being chamfered and in a direction of rotation that is opposite to the direction of rotation of the workpiece 8 when flank edges 61-64 of external teeth 60 on a workpiece are being chamfered.

All flank edges 61-64 are preferably chamfered in a machining direction from the tooth root 66 to the tooth tip 65 of the associated tooth 60.

In order to achieve a chamfering of each one of the first and second flank edges 61 ,62 of the teeth 60 on the workpiece 8 in a machining direction from the tooth root 66 to the tooth tip 65, the above-mentioned step b comprises the following substeps:
b1) chamfering the first flank edges 61 of the teeth 60 on the workpiece 8, while rotating the workpiece about its central axis 4 in the above-mentioned first direction of rotation R1 and while rotating the milling tool 1 about the axis of rotation 3 of the tool body 2 in the same direction of rotation R1 as the workpiece 8 when the first flank edges 61 that are being chamfered are flank edges of internal teeth 60 on the workpiece 8 or in an opposite direction of rotation R2 when the first flank edges 61 that are being chamfered are flank edges of external teeth 60 on the workpiece 8; and
b2) chamfering the second flank edges 62 of the teeth 60 on the workpiece 8, while rotating the workpiece about its central axis 4 in the above-mentioned second direction of rotation R2, opposite to the first direction of rotation R1, and while rotating the milling tool 1 about the axis of rotation 3 of the tool body 2 in the same direction of rotation R2 as the workpiece 8 when the second flank edges 62 that are being chamfered are flank edges of internal teeth 60 on the workpiece 8 or in an opposite direction of rotation R1 when the second flank edges 62 that are being chamfered are flank edges of external teeth 60 on the workpiece 8.

In order to achieve a chamfering of each one of the third and fourth flank edges 63, 64 of the teeth 60 on the workpiece 8 in a machining direction from the tooth root 66 to the tooth tip 65, the above-mentioned step e comprises the following substeps:
e1) chamfering the third flank edges 63 of the teeth 60 on the workpiece 8, while rotating the workpiece about its central axis 3 in the first direction of rotation R1, and while rotating the milling tool 1 about the axis of rotation 3 of the tool body 2 in the same direction of rotation R1 as the workpiece 8 when the third flank edges 63 that are being chamfered are flank edges of internal teeth 60 on the workpiece 8 or in an opposite direction of rotation R2 when the third flank edges 63 that are being chamfered are flank edges of external teeth 60 on the workpiece 8; and
e2) chamfering the fourth flank edges 64 of the teeth 8 on the workpiece 8, while rotating the workpiece about its central axis 4 in the second direction of rotation R2, and while rotating the milling tool 1 about the axis of rotation 3 of the tool body 2 in the same direction of rotation R2 as the workpiece 8 when the fourth flank edges 64 that are being chamfered are flank edges of internal teeth 60 on the workpiece 8 or in an opposite direction of rotation R1 when the fourth flank edges 64 that are being chamfered are flank edges of external teeth 60 on the workpiece 8.

The invention is of course not in any way restricted to the embodiments described above. On the contrary, many possibilities to modifications thereof will be apparent to a person with ordinary skill in the art without departing from the basic idea of the invention such as defined in the appended claims.

1. A milling tool for chamfering flank edges of internal or external teeth on a cylindrical toothed workpiece at opposite end faces of the workpiece the milling tool (1) comprising:
an elongated tool body, which at a rear end has a rear part configured for attachment to a machine and at a distance from the rear part having a cutting part provided with cutting edges that, the tool body comprising:
an elongated shank part which carries the cutting part and extends from the cutting part towards the rear part and which has a front end facing the cutting part, an opposite rear end and a peripheral surface extending around the shank part between the rear end and the front end thereof, wherein the shank part has a longitudinal central axis that coincides with an axis of rotation of the tool body; and
the cutting part being provided with at least one pair of cutting edges consisting of a first cutting edge facing away from the rear part and a second cutting edge facing the rear part and located closer to the rear part than the first cutting edge, wherein:
the first cutting edge has a rear end and an opposite front end, the rear end of the first cutting edge being located closer to the rear part of the tool body than the front end of the first cutting edge, wherein the front end of the first cutting edge is located closer to the axis of rotation than the rear end of the first cutting edge and the distance between the first cutting edge and the axis of rotation is gradually increasing as seen in a direction along the first cutting edge from the front end thereof to the rear end thereof, and
the second cutting edge has a front end and an opposite rear end, the rear end of the second cutting edge being located closer to the rear part (6) of the tool body than the front end of the second cutting edge, wherein the rear end of the second cutting edge is located at a longer distance from the axis of rotation than a radially outermost part of the peripheral surface of the shank part, and wherein the rear end of the second cutting edge is located closer to the axis of rotation than the front end of the second cutting edge and the distance between the second cutting edge and the axis of rotation is gradually increasing as seen in a direction along the second cutting edge from the rear end thereof to the front end thereof;
the cutting part having an extension in the axial direction of the tool body limited to an area between a first plane that extends perpendicularly to the axis of rotation and intersects the rear end of the second cutting edge and a second plane that extends perpendicularly to the axis of rotation and intersects the front end of the first cutting edge; and
the cutting part constituting an axially foremost part of the tool body or the tool body includes a front part that projects from the cutting part on the side thereof facing away from the rear part, and wherein the front end of the first cutting edge is located at a longer distance from the axis of rotation than a radially outermost part of this front part.

2. The milling tool according to claim 1, wherein the first cutting edge (11) extends substantially rectilinearly in a third plane that contains the axis of rotation, and wherein the second cutting edge extends substantially rectilinearly in a fourth plane that contains the axis of rotation, wherein the fourth plane coincides with the third plane.

3. The milling tool according to claim 2, wherein the first cutting edge has such an inclination in the third plane that an extension of the first cutting edge forms a first angle with the axis of rotation, the first angle being larger than or equal to 20° and smaller than 90°, and wherein the second cutting edge has such an inclination in the fourth plane that an extension of the second cutting edge forms a second angle with the axis of rotation, the second angle being larger than or equal to 20° and smaller than 90°, wherein the first and second angles are substantially equal.

4. The milling tool according to claim 2, wherein the first cutting edge is formed at an intersection between a first surface on the cutting part and a second surface on the cutting part, wherein the first surface and the second surface are mirror symmetrical to each other with respect to the third plane, wherein the second cutting edge is formed at an intersection between a third surface on the cutting part and a fourth surface on the cutting part, and wherein the third surface and the fourth surface are mirror symmetrical to each other with respect to the fourth plane.

5. The milling tool according to claim 1, wherein the first cutting edge and the second cutting edge are mirror symmetrical to each other with respect to a plane of symmetry that extends halfway between the first and second cutting edges perpendicularly to the axis of rotation.

6. The milling tool according to claim 1, wherein the radial distance between the rear end of the second cutting edge and the radially outermost part of the peripheral surface of the shank part is 2-40 mm.

7. The milling tool according to claim 1, wherein the cutting part includes a holder arm that projects in a radial direction in relation to the axis of rotation beyond the radially outermost part of the peripheral surface of the shank part wherein the holder arm has an inner end facing the axis of rotation and an opposite outer end, and wherein the first and second cutting edges are arranged on the holder arm at the outer end thereof.

8. The milling tool according to claim 7, wherein the first and second cutting edges form part of a cutting insert that is releasably mounted to an insert seat provided at the outer end of the holder arm.

9. The milling tool according to claim 7, wherein the cutting part includes a base, which carries the holder arm and which is slidably mounted to the shank part at the front end thereof so as to be linearly slidable in relation to the shank part perpendicularly to the axis of rotation and in a longitudinal direction of the holder arm, wherein the base is lockable to the shank part in different sliding positions in relation to the shank part to thereby allow an adjustment of the radial distance between the first cutting edge and the axis of rotation and the radial distance between the second cutting edge and the axis of rotation.

10. The milling tool according to claim 1, wherein the shank part is rod-shaped.

11. The milling tool according to claim 1, wherein the shank part has a length of 25-500 mm.

12. The milling tool according to claim 1, wherein the cutting part is detachably mounted to the shank part at the front end thereof.

13. A method for chamfering flank edges of internal or external teeth on a cylindrical toothed workpiece at a first end face of the workpiece and at an opposite second end face of the workpiece wherein each tooth on the workpiece has a tooth tip a tooth root a first tooth flank surface extending between the tooth tip and the tooth root on a first side of the tooth and a second tooth flank surface extending between the tooth tip and the tooth root on an opposite second side of the tooth, a first flank edge being formed at an intersection between the first tooth flank surface and the first end face of the workpiece, a second flank edge being formed at an intersection between the second tooth flank surface and the first end face of the workpiece, a third flank edge being formed at an intersection between the first tooth flank surface and the second end face of the workpiece and a fourth flank edge being formed at an intersection between the second tooth flank surface and the second end face of the workpiece, wherein the workpiece is attached to a machine and rotatable by the machine about a central axis of the workpiece (8) and wherein the chamfering is performed by means of a milling tool according to claim 1, which is attached to the machine and rotatable by the machine about the axis of rotation of the tool body and moveable by the machine in relation to the workpiece in the axial direction of the workpiece and in different directions in a plane perpendicular to the central axis of the workpiece with the axis of rotation of the tool body being in parallel with the central axis of the workpiece the method comprising the steps of:
a) positioning the milling tool in a first predefined position in relation to the workpiece with the axis of rotation of the tool body in parallel with the central axis of the workpiece and with the cutting part of the tool body adjacent to the first end face of the workpiece and with one of the first and second cutting edges of the at least one pair of cutting edges facing this first end face;
b) rotating the milling tool about the axis of rotation of the tool body (2) and simultaneously rotating the workpiece about its central axis with a predefined relationship between the speed of rotation of the milling tool and the speed of rotation of the workpiece, while keeping the axis of rotation of the tool body in parallel with the central axis of the workpiece and moving the milling tool along a predefined path in relation to the workpiece such that the cutting edge or cutting edges facing the first end face of the workpiece chamfers the first and second flank edges of the teeth on the workpiece;
c) moving the milling tool in relation to the workpiece to move the cutting edge or cutting edges facing the first end face of the workpiece out of contact with the workpiece;
d) moving the milling tool in relation to the workpiece to a second predefined position with the axis of rotation of the tool body (2) in parallel with the central axis of the workpiece and with the cutting part of the tool body adjacent to the opposite second end face of the workpiece and with the other one of the first and second cutting edges of the at least one pair of cutting edges facing this second end face (9b); and
e) rotating the milling tool about the axis of rotation of the tool body and simultaneously rotating the workpiece about its central axis with a predefined relationship between the speed of rotation of the milling tool and the speed of rotation of the workpiece, while keeping the axis of rotation of the tool body in parallel with the central axis of the workpiece and moving the milling tool along a predefined path in relation to the workpiece such that the cutting edge or cutting edges facing the second end face of the workpiece chamfers the third and fourth flank edges of the teeth on the workpiece.

14. The method according to claim 13, wherein said the predefined path for the movement of the milling tool in relation to the workpiece in step b) includes at least one part in which the milling tool is moved in its axial direction to thereby move the cutting edge or cutting edges facing the first end face of the workpiece in a direction towards this first end face, and/or wherein the predefined path for the movement of the milling tool in relation to the workpiece in step e) includes at least one part in which the milling tool is moved in its axial direction to thereby move the cutting edge or cutting edges facing the second end face of the workpiece in a direction towards this second end face.

15. The method according to claim 13, wherein said the predefined path for the movement of the milling tool in relation to the workpiece in step b) includes at least one part in which the distance between the axis or rotation of the tool body and the central axis of the workpiece is changed, and/or wherein said the predefined path for the movement of the milling tool in relation to the workpiece in step e) includes at least one part in which the distance between the axis or rotation of the tool body and the central axis of the workpiece is changed.

16. The method according to claim 13, wherein:
the first flank edges and the second flank edges of the teeth on the workpiece are each chamfered in a machining direction from the tooth root to the tooth tip of the associated tooth in step b), and
the third flank edges and the fourth flank edges of the teeth on the workpiece are each chamfered in a machining direction from the tooth root to the tooth tip of the associated tooth in step e).

17. The method according to claim 16, wherein step b) further comprises the steps of:
b1) chamfering the first flank edges of the teeth on the workpiece while rotating the workpiece about its central axis in a first direction of rotation with the second tooth flank surfaces as leading tooth flank surfaces and with the first tooth flank surfaces as trailing tooth flank surfaces, and while rotating the milling tool about the axis of rotation of the tool body in the same direction of rotation as the workpiece when the first flank edges that are being chamfered are flank edges of internal teeth on the workpiece or in an opposite direction of rotation when the first flank edges that are being chamfered are flank edges of external teeth on the workpiece, and
b2) chamfering the second flank edges of the teeth on the workpiece, while rotating the workpiece about its central axis in a second direction of rotation opposite to the first direction of rotation and while rotating the milling tool about the axis of rotation of the tool body in the same direction of rotation as the workpiece when the second flank edges that are being chamfered are flank edges of internal teeth on the workpiece or in an opposite direction of rotation when the second flank edges that are being chamfered are flank edges of external teeth on the workpiece.

18. The method according to claim 17, wherein step e) further comprises the steps of:
e1) chamfering the third flank edges of the teeth on the workpiece while rotating the workpiece about its central axis in the first direction of rotation and while rotating the milling tool about the axis of rotation of the tool body in the same direction of rotation as the workpiece when the third flank edges that are being chamfered are flank edges of internal teeth on the workpiece (8) or in an opposite direction of rotation when the third flank edges that are being chamfered are flank edges of external teeth on the workpiece and
e2) chamfering the fourth flank edges of the teeth on the workpiece while rotating the workpiece about its central axis in the second direction of rotation and while rotating the milling tool about the axis of rotation of the tool body in the same direction of rotation as the workpiece (8) when the fourth flank edges that are being chamfered are flank edges of internal teeth on the workpiece or in an opposite direction of rotation when the fourth flank edges that are being chamfered are flank edges of external teeth on the workpiece

19. A computer readable medium comprising computer program having instructions, which when executed by a CNC machine causes the CNC machine to perform the method according to claim 13.
